(19) United States
(12) Patent Application Publication
(10) Pub. No.: US 2006/0147587 A1
(43) Pub. Date: Jul. 6, 2006

(54) Square bottom taco shell

(76) Inventors: Nicholas Daniel Kovich, Minneapolis, MN (US); Anthony W. Richards, Poplar, WI (US)

Correspondence Address: GENERAL MILLS, INC., P.O. BOX 1113, MINNEAPOLIS, MN, 55440, US

(21) Appl. No.: 10/501,298

(22) PCT Filed: Nov. 14, 2002
(86) PCT No.: PCT/US02/36474

§ 371 Date: Jul. 12, 2004

(51) Int. Cl. A21D 13/00

(52) U.S. Cl. 426/138

(57) ABSTRACT

A stable, self-standing, taco shell is provided. The taco shell has a first sidewall element, a second sidewall element, a substantially flat base element of defined width, a first curved element interconnecting the first sidewall element to the flat base element; and a second curved element interconnecting the second sidewall element to the flat base element. Methods of fabrication and use are disclosed.

### FIELD OF THE INVENTION

The present invention relates to an edible food shell. More specifically, the present invention relates to a taco shell.

### BACKGROUND OF THE INVENTION

A conventional taco shell is formed by placing a circular tortilla in a U-shaped mold. The tortillas used for conventional tacos are typically between 5.0 and 7.5 inches in diameter. Once the tortilla has taken on the shape of the mold, the tortilla is made generally rigid by baking or deep fat frying. The resulting taco shell 10 is U-shaped when viewed from the end (see FIG. 1).

As shown in FIG. 1, a conventional taco shell 10 will have a pair of opposed sidewalls 15 that are interconnected by a generally semi-circular or round base 20. Often, each sidewall 15 diverges from the vertical centerline of the shell 10 by approximately 25 degrees, as indicated by angle “A” in FIG. 1. The top edge 25 of each sidewall 15 is free of connection to the opposing sidewall 15, creating the open end 30 of the shell 10. The sidewalls 15 and base 20 define a cavity 35 in which taco filling (e.g., lettuce, beans, cheese, cooked meat or poultry or the like) is placed.

As can be seen in FIG. 1, the base 20 of the conventional taco shell 10 is relatively narrow as compared to the height of the shell 10. The conventional taco shell's configuration and narrow base 20 prevent taco consumers from filling the cavity 35 with preferred amounts of meat without overly limiting the space available for other types of taco filling. For example, if a consumer puts in more than minor amounts of meat, the remaining space within the cavity 35 is insufficient to allow the inclusion of adequate amounts of other available fillings like lettuce, cheese, tomatoes, black olives, sour cream, etc. Another problem is that the narrow base 20 prevents a utensil (e.g., a spoon) from being placed near the base of the taco shell 10 when used to fill the taco shell 10 with meat or other filling.

Another problem presented by the configuration of the conventional taco shell 10 is that the shell 10 tends to fail at the base 20. When this occurs, the shell 10 no longer retains the taco filling. Consequently, the taco filling, especially the liquid elements like taco sauce and meat juices, escape from the taco shell 10 making a mess.

Another problem presented by the configuration of the conventional taco shell 10 is that the narrow, rounded base 20 prevents the taco shell 10 from being stable in an upright position. Consequently, when not being held, a conventional taco shell 10 must be laid on its side to prevent the shell 10 from tipping over. However, when the taco shell 10 is on its side, the shell 10 can no longer hold the taco filling, which spills out through the open end 30 of the shell 10.

In order to hold taco shells upright, various taco shell holders have been devised. Typically, the taco shell holder has a body with a wide base and a taco shell receiving opening in which the taco shell sits while it is filled with the taco filling. However, the taco shell holders are not edible and, therefore, generate a significant amount of waste. Furthermore, in the fast-food-take-out environment, taco shell holders make it difficult to package the taco shell when the taco shell is filled with taco shell filling. Supplemental packaging such as taco stands adds costs as well.

There is a need in the art for a taco shell that is capable of standing without assistance whether initially or partially consumed. Also, there is a need in the art for methods for manufacturing and using such a taco shell.

### BRIEF SUMMARY OF THE INVENTION

The present invention, in several embodiments, is a stable, self-standing, taco shell. In one embodiment the stable, self-standing, taco shell has a first sidewall and a second sidewall interconnected by a substantially flat base. The taco shell is configured so the height of the taco shell is approximately 1.50 to 4.0 times the width of the base.

In one embodiment, the stable, self-standing, taco shell has a first sidewall and a second sidewall interconnected by a substantially flat base. The taco shell is configured so that the height of the taco shell is approximately about 50-110 millimeters (2.0 to 4.0 inches) and the width of the base is at least 10-15 millimeters (0.50 inch). In another embodiment, the width of the base is at least 19 millimeters (about 0.75 inch). In yet another embodiment, the width of the base is approximately 25 mm (about 1.0 inch).

In one embodiment, the stable, self-standing, taco shell has a first sidewall element, a second sidewall element, a substantially flat base element, a first curved element interconnecting the first sidewall element to the flat base element, and a second curved element interconnecting the second sidewall element to the flat base element. In one embodiment of this taco shell, at least one of the elements will have a thickness of at least 1.5 millimeters. In one embodiment of this taco shell, at least one of the elements will have a thickness of less than 1.5 millimeters. In other embodiments of this taco shell, the curved elements may have large, medium or small radii.

The present invention, in several embodiments, further resides in methods of making a stable, self-standing, taco shell. In one embodiment, the method entails providing a soft flexible uncooked or partially cooked tortilla and placing the tortilla in or on a mold. The mold is configured so the resulting taco shell has a first sidewall and a second sidewall interconnected by a substantially flat base, and the height of the resulting taco shell is approximately 1.50 to 4.0 times the base width of the taco shell.

In one embodiment, the present methods of making a stable, self-standing, taco shell involves providing a tortilla and placing the tortilla into or on a mold. The mold is configured so the resulting taco shell has a first sidewall element, a second sidewall element, a substantially flat base element, a first curved element interconnecting the first sidewall element to the fat base element, and a second curved element interconnecting the second sidewall element to the flat base element. In one embodiment of this method, at least one of the elements will have a thickness of at least 1.5 millimeters. In one embodiment of this method, at least one of the elements will have a thickness of less than 1.5 millimeters. In other embodiments of this method, the curved elements may have large, medium or small radii.

The present invention, in several embodiments, is a method of using a stable, self-standing, taco shell. The method involves locating a flat preparation surface and selecting at least one stable, self-standing, taco shell having a first sidewall and a second sidewall interconnected by a substantially flat base, the taco shell configured so the height of the taco shell is approximately 1.50 to 4.0 times the width of the base. The at least one taco shell is then placed upright on the preparation surface and filled with taco filling.

In one embodiment, the method of using a stable, self-standing, taco shell entails locating a flat preparation surface and selecting at least one stable, self-standing, taco shell having a first sidewall element, a second sidewall element, a substantially flat base element, a first curved element interconnecting the first sidewall element to the flat base element, and a second curved element interconnecting the second sidewall element to the flat base element. The at least one taco shell is then placed upright on the preparation surface and filled with taco filling. In one embodiment of this method, at least one of the elements will have a thickness of at least 1.5 millimeters. In one embodiment of this method, at least one of the elements will have a thickness of less than 1.5 millimeters. In other embodiments of this method, the curved elements may have large, medium or small radii.

While multiple embodiments are disclosed, still other embodiments of the present invention will become apparent to those skilled in the art from the following detailed description, which shows and describes illustrative embodiments of the invention. As will be realized, the invention is capable of modifications in various obvious aspects, all without departing from the spirit and scope of the present invention. Accordingly, the drawings and detailed description are to be regarded as illustrative in nature and not restrictive.

### BRIEF DESCRIPTION OF THE DRAWINGS

FIG. 1 is an end elevation view of a conventional U-shaped taco shell.

FIG. 2 is an isometric view of a self-standing taco shell having a substantially flat base and sitting upright on a flat preparation surface.

FIG. 3a is an end elevation view of the self-standing taco shell of FIG. 2 having large radius curved segments.

FIG. 3b is an end elevation view of the self-standing taco shell of FIG. 2 having medium radius curved segments.

FIG. 3c is an end elevation view of the self-standing taco shell of FIG. 2 having small radius curved segments.

FIG. 3d is an end elevation view of the self-standing taco shell of FIG. 2 after the shell has failed at one of the shell's two curved segments.

FIG. 4 is an isometric view of a self-standing food trough having a substantially flat base and sitting upright on a flat preparation surface.

FIG. 5 is an end elevation view of the self-standing food trough of FIG. 4.

FIG. 6 is a flow chart illustrating a method of manufacturing a self-standing taco shell having a substantially flat base.

FIG. 7 is a flow chart illustrating a method of using a self-standing taco shell having a substantially flat base.

FIG. 8 is an isometric view of a tray having a surface that may be used to further stabilize the taco shell of the present invention.

### DETAILED DESCRIPTION

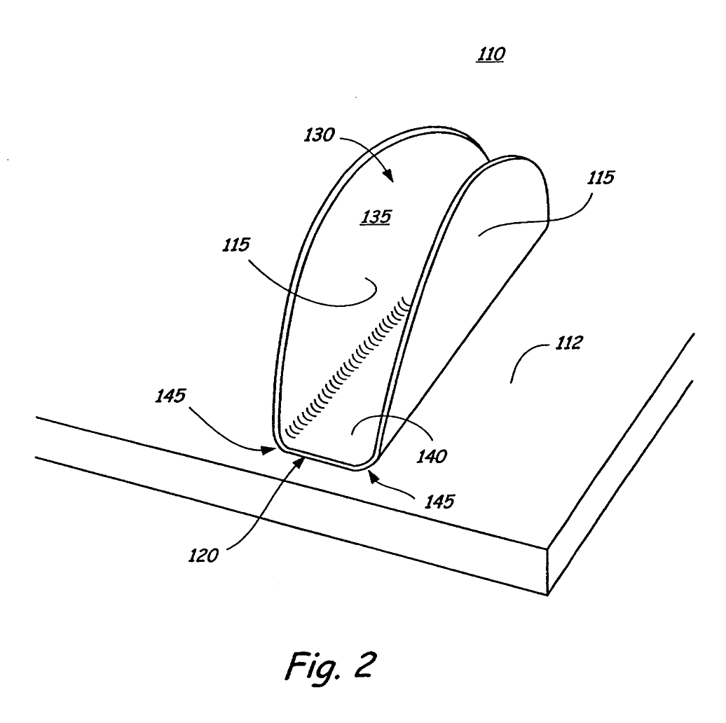

FIG. 2 is an isometric view of a self-standing taco shell 110 formed from a circular tortilla. FIG. 2 depicts the taco shell 110 sitting upright, without assistance, on a flat preparation surface 112.

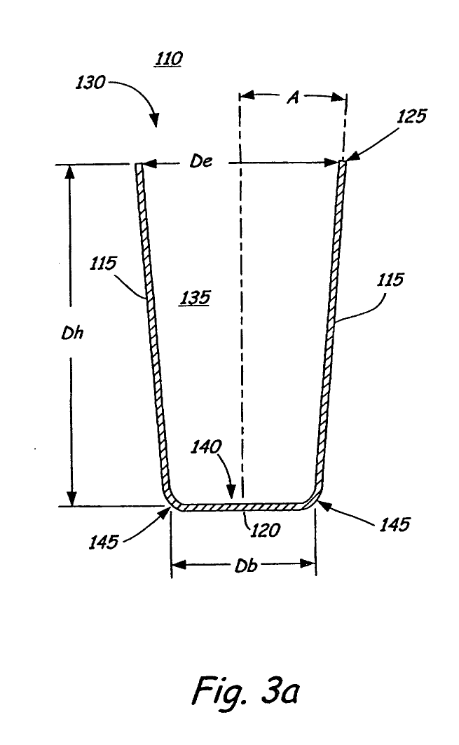

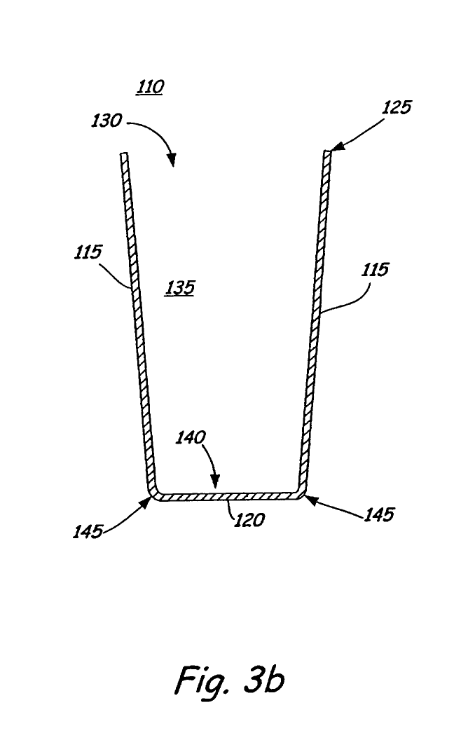

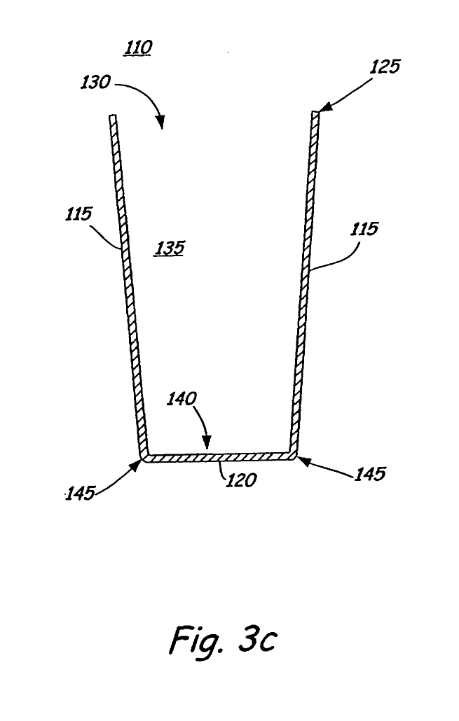

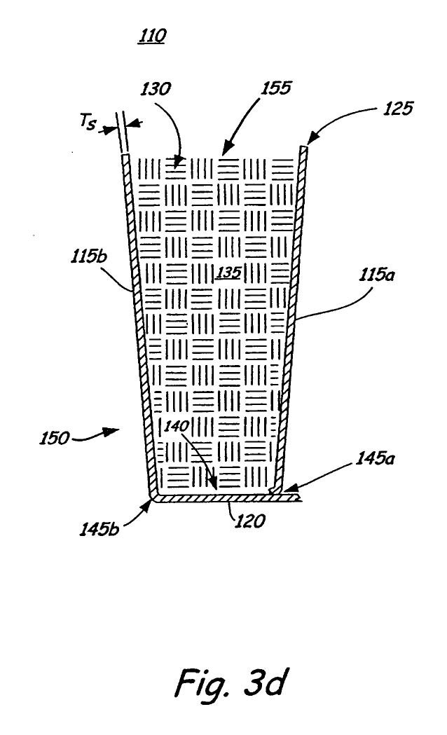

FIG. 3a is an end elevation view of the same self-standing taco shell 110 shown in FIG. 2. As shown in FIG. 3a, the taco shell 110 includes a pair of opposed sidewalls 115 that are interconnected by a flat base 120. The top edge 125 of each sidewall 115 is free of connection to the opposing sidewall 115, creating the open end 130 of the shell 110. The sidewalls 115 and base 120 define a cavity 135 in which taco filling (e.g., lettuce, beans, cheese, cooked meat or poultry or the like) is placed.

The base 120 comprises a flat segment 140, which is bordered by two curved segments 145. Each curved segment 145 serves as a transition from the base 120 to a sidewall 115. In one embodiment of the invention, as reflected in FIG. 3a, the radii of the curved segments are large (approximately 6 millimeters or greater), forming rounded transitions from the base 120 to the sidewalls 115. In one embodiment of the invention, as shown in FIG. 3b, the radii of the curved segments 145 are medium (approximately 6 millimeters to 3 millimeters). In one embodiment of the invention, as indicated in FIG. 3c, the radii of the curved segments are small (approximately 3 millimeters or less), forming transitions from the base 120 to the sidewalls 115 that have a profile with a very pronounced edge. As a general rule, the larger the radius of a curved segment 145, the less likely the shell 110 will fail at that curved segment 145.

As indicated in FIG. 3a, each sidewall 115 can diverge from the vertical centerline of the shell 110. Potential angles of divergence range from about zero to about 25 degrees, as indicated by angle “A” in FIG. 3a.

Excessive angles of divergence “A” in conventional taco shells 10 cause taco consumers to close or pinch the top edges 25 of the shell 10 together, bringing about taco shell failure. To overcome this problem, some embodiments of a taco shell of the present invention may include less divergence than that of a conventional taco. For instance, one embodiment of the taco shell 110 has a base width (represented by letters “Db” in FIG. 3a) of approximately 19 to 32 millimeters (about 0.75 to 1.25 inches) while the open end width (represented by letters “De” in FIG. 3a) is approximately 32 to 35 millimeters (about 1.25 to 1.375 inches). In another embodiment, the base width Db is approximately 19 to 39 millimeters (about 0.75 to 1.5 inches) and the open end width De is approximately 35 to 44 millimeters (about 1.375 to 1.75 inches). In another embodiment, the base width Db is approximately 19 to 39 millimeters (about 0.75 to 1.5 inches) and the open end width De is approximately 44 to 51 millimeters (about 1.75 to 2.0 inches). Finally, in yet another embodiment, the base width Db is approximately 25 millimeters (about 1.0 inch) and the open end width is approximately 39 millimeters (about 1.5 inches).

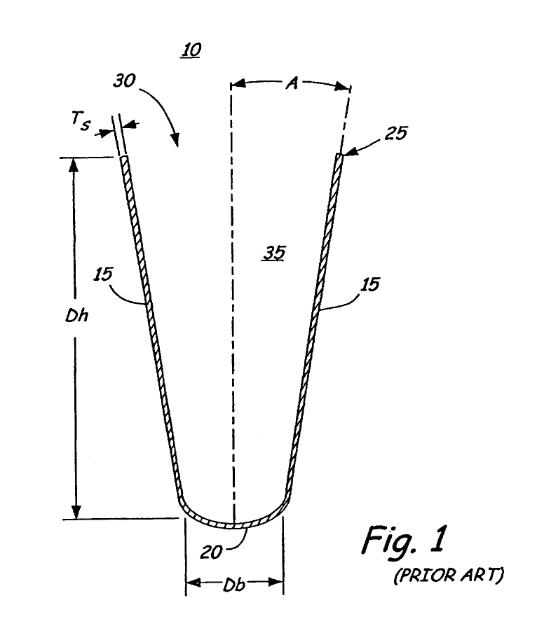

As shown in FIG. 3a, in one embodiment of the invention, the flat base 120 of the taco shell 110 is wider than the rounded base 20 of the conventional taco shell 10 illustrated in FIG. 1. The base 120 of the taco shell 110 has been increased so that the height (represented by letters “Dh” in FIG. 3a) of the shell 110 is now approximately 1.50 to 4.0 times the base width Db. Because of its width Db, the base 120 of the taco shell 110 is able to overcome the destabilizing effect presented by the normal variations in the surface topography of a taco shell 110. Thus, the base 120 allows the taco shell 110 to stand upright without assistance when the taco shell 110 is being filled with taco filling. Also, the base 120 allows a taco, which has been partially consumed, to stand upright without assistance.

In one embodiment, the taco shell 110 has a height of approximately 51 to 65 millimeters (about 2.0 to 2.5 inches), a base width Db of approximately 19 to 32 millimeters, and an open end width De of approximately 32 to 39 millimeters. This taco shell's relatively narrow open end width De and its low height Dh to base width Db ratio results in a self-standing taco shell 110 that is especially stable in the upright position. This taco's relatively broad flat base 120 allows the taco shell 110 to successfully over come the destabilizing effect presented by the normal variations in the surface topography of a taco shell.

In one embodiment of the invention, the base width Db of the taco shell 110 is such that the taco height Dh is less than 4.0 times the base width Db. In another embodiment, the height Dh of the taco shell 110 is approximately 1.75 to 3.35 times the base width Db. In yet another embodiment, the height Dh of the taco shell 110 is approximately 2.0 to 3.0 times the base width Db. Finally, in another embodiment, the height Dh of the taco shell 110 is approximately 2.0 to 2.5 times the base width Db.

In one embodiment of the invention, the height Dh of the taco shell 110 is approximately 51 to 102 millimeters (about 2.0 to 4.0 inches) while the base width Db is at least approximately 12 millimeters (about 0.50 inch). In another embodiment, the height Dh of the taco shell 110 is approximately 51 to 102 millimeters while the base width Db is at least approximately 16 millimeters (about 0.65 inch). In yet another embodiment, the height Dh of the taco shell 110 is approximately 51 to 102 millimeters while the base width Db is at least approximately 19 millimeters. In yet another embodiment, the height Dh of the taco shell 110 is approximately 51 to 102 millimeters while the base width Db is at least approximately 21 millimeters (about 0.85 inch). Finally, in another embodiment, the height Dh of the taco shell 110 is approximately 51 to 102 millimeters while the base width Db is at least approximately 25 millimeters.

In one embodiment of the invention, the height Dh of the taco shell 110 is approximately 57 to 77 millimeters (about 2.25 to 3.0 inches) and the base width Db is at least approximately 16 millimeters. In one embodiment of the invention, the height Dh of the taco shell 110 is approximately 57 to 70 millimeters (about 2.25 to 2.75 inches) and the base width Db is at least approximately 19 millimeters. In one embodiment of the invention, the height Dh of the taco shell is approximately 57 to 70 millimeters and the base width Db is at least approximately 21 millimeters. In one embodiment of the invention, the height Dh of the taco shell is approximately 57 to 70 millimeters and the base width Db is at least approximately 25 millimeters.

In one embodiment of the invention, the base width Db of the taco shell 110 is no wider than the distance an average adult mouth may comfortably open when consuming a taco. In one embodiment, the base width Db is approximately 25 millimeters. In another embodiment, the base width Db of the taco shell 110 is no wider than the distance an average child mouth may comfortably open when consuming a taco.

A comparison of the taco shell 110 (illustrated in FIG. 3a) to the conventional taco shell 10 (illustrated in FIG. 1) shows the cavity 135 of the taco shell 110 is larger than the cavity 35 of the conventional taco shell 10. Consequently, the taco shell 110 can hold a greater amount of taco filling than the conventional taco shell 10. This is advantageous because the taco shell 110 can be filled with greater amounts of meat and still have room for adequate amounts of all other available fillings. Typically, a taco shell filled with adequate amounts of meat and all other available fillings will have greater flavor and, as a result, will be preferred by a taco consumer. Another advantage of the taco shell 110 is that the larger cavity 135 and base 120 allow a utensil (e.g., spoon) to be used to access the base of the taco shell 110 when used to load the taco shell 110 with taco filling.

The configuration of the taco shell 110 (shown in FIGS. 3a, 3b and 3c) causes the shell 110 to fail primarily at one of its two curved segments 145. This failure occurs primarily at these segments because stress concentrations arise at the curved segments 145. The smaller the radius of a curved segment 145, the greater the stress concentration therein and the more likely the shell 110 will fail at that location.

As shown in FIG. 3d, when one of the two curved segments 145a, 145b fails, a L-shaped shell section 150 remains. The L-shaped shell section 150 comprises the flat segment 140 and one sidewall 115b joined by the remaining unbroken curved segment 145b. Since the resulting L-shaped shell section 150 has a sidewall 115b connected to the flat segment 140, the shell 110 can still retain the taco filling 155, including any taco sauce and meat juice. Thus, unlike a conventional taco shell 10, the taco shell 110 can retain its filling 150 though the shell 110 has failed.

As indicated in FIG. 3d, the free sidewall 115a slides towards the other sidewall 115b until its progress is arrested by the taco filling 155 contained in the cavity 135. The taco can then be consumed like a sandwich.

Because the taco shell 110 can fail at one of its curved segments 145 and still retain the taco filling 155, preventing the failure of the taco shell 110 is less of a concern than it is with the conventional shell 10. Consequently, in one embodiment of the invention, the taco shell 110 may be made from a tortilla having a thickness (“Ts” in FIG. 3d) of less than 1.5 millimeters (i.e., a thin tortilla).

To reduce the likelihood of shell failure, conventional taco shells 10 are made from tortillas having a thickness (“Ts” in FIG. 1) of 1.5 millimeters or greater. Thus, the taco shell 110 made from the “thin tortilla” is advantageous over the conventional taco shell 10 because less dough is required for each taco shell 110. Also, since some fried taco shells are high in fat content, the consumer ingests less fat per taco when the taco shell 110 is made from a “thin tortilla.” Also, with the “thin tortilla” embodiment, more taco shells can be provided for a given package weight. Conversely, for the same number of taco shells, ingredient amounts and costs are lowered for the “thin tortilla” embodiment over the embodiment having a thicker tortilla thickness.

The taco shell 110 of the present invention may be made using a tortilla having a thickness less than 1.5 millimeters or a thickness greater than or equal to 1.5 millimeters. Consequently, in one embodiment, the taco shell 110 can be made from a standard tortilla having a thickness Ts of approximately 1.5 to 3.0 millimeters or greater.

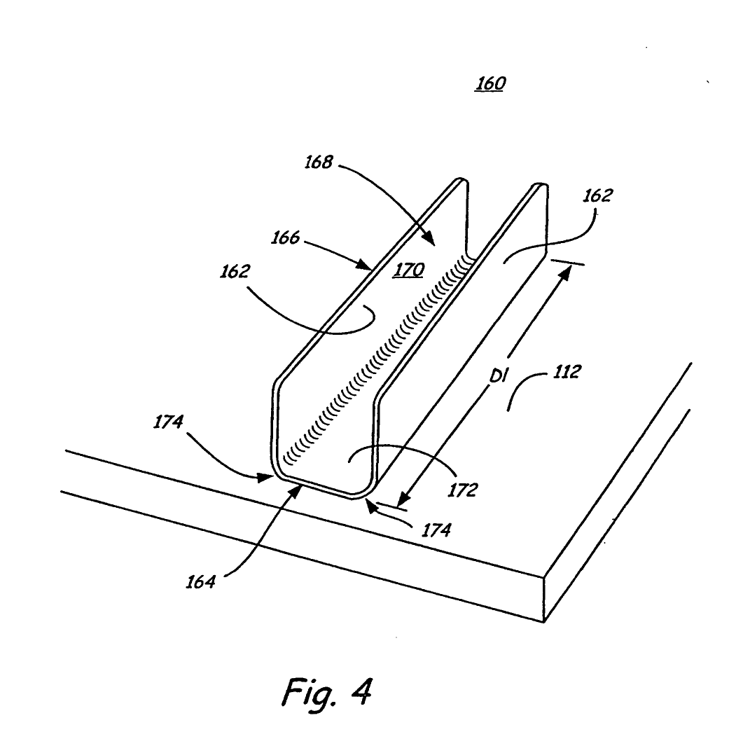

FIG. 4 is an isometric view of an alternative embodiment of the self-standing taco shell 110 called the self-standing food trough 160. FIG. 4 depicts the food trough 160 sitting upright, without assistance, on a flat preparation surface 112.

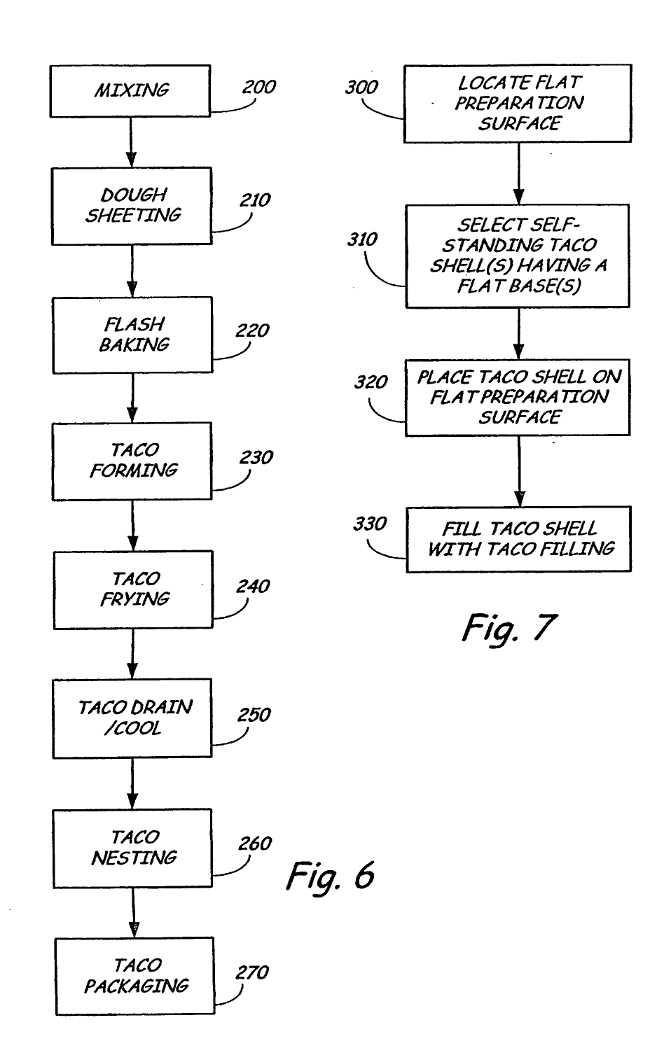

In one embodiment, the food trough 160 is formed from a circular tortilla in a manner as outlined in FIG. 6 and discussed below. In another embodiment, the food trough 160 is actually a cookie or cracker. This embodiment is made by cooking cracker or cookie dough in molds configured like the food trough 160 in FIG. 4.

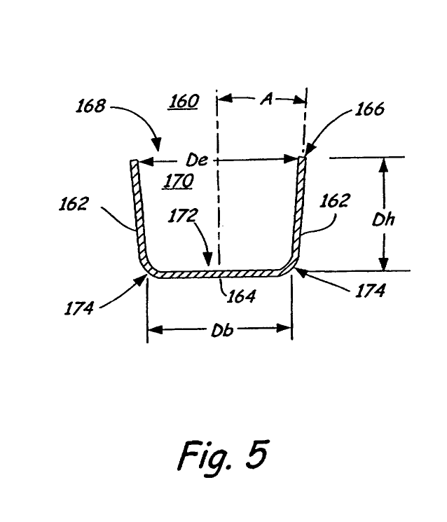

The food trough 160 can be made in many different sizes. Generally, the food trough 160 is longer (the length depicted in FIG. 4 by the dimension D1) than it is wide (the width depicted in FIG. 5 by the dimension Db).

FIG. 5 is an end elevation view of the same self-standing food trough 160 shown in FIG. 4. As shown in FIG. 5, the food trough 160 includes a pair of opposed sidewalls 162 that are interconnected by a flat base 164. The top edge 166 of each sidewall 162 is free of connection to the opposing sidewall 162, creating the open end 168 of the trough 160. The sidewalls 162 and base 164 define a cavity 170 in which an edible filling is placed.

The base 164 comprises a flat segment 172, which is bordered by two curved segments 174. Each curved segment 174 serves as a transition from the base 164 to a sidewall 162. In one embodiment of the trough 160, its curved segments 174 will have ranges of radii similar to those of the taco shell 110. The trough 160 have a range for angles of divergence (represented by angle “A” in FIG. 5) that are similar to those of the taco shell 110.

In one embodiment of the food trough 160, its height Dh will be less than the height Dh of the taco shell 110. In another embodiment, the height Dh of the food trough 160 will be limited to the distance an average adult mouth can comfortably open when consuming a sandwich. In another embodiment, the height Dh of the food trough 160 will be limited to the distance an average child mouth can comfortably open when consuming a sandwich. In yet another embodiment, the height Dh of the food trough will be approximately 12 to 25 millimeters (about 0.50 to 1.0 inch).

In the large embodiment of the food trough 160, its base width Db will be at least approximately 25 millimeters. In another embodiment, the base width Db of the food trough 160 will be limited to the bite width of an average adult mouth. In another embodiment, the base width Db of the food trough 160 will be limited to the bite width of an average child mouth. In yet another embodiment, the base width Db of the food trough 160 will be approximately 25 millimeters to 51 millimeters.

The length of the food trough 160 can be varied. In one embodiment, the length will be about 127 millimeters (about 5 inches).

These embodiments are advantageous because the food trough 160, when used as a taco shell, allows the taco to be eaten like a hot dog. As a result, a taco consumer may eat a taco without having to tilt his or her head to the right or left, as is typically required when eating a taco in a conventional taco shell 10.

A process of making the self-standing taco shell 110 will now be described by referring to the process flow chart illustrated in FIG. 6. Initially, masa dough is formed. As one of ordinary skill in the art would recognize, this may be done by purchasing masa dough from a vendor, purchasing masa flour and mixing it with water, annatto (an optional yellow coloring), salt and rework to form the dough (block 200), or by purchasing raw corn and processing it to make the masa dough. If raw corn is purchased, the raw corn is cooked with lime and then steeped. The corn is then washed and ground into masa flour, which is then mixed with other ingredients to form the dough. The dough enters the sheeting machine, which forms raw masa tortillas (block 210). In one embodiment of the invention, the tortillas will have a thickness of less than 1.5 millimeters. In another embodiment of the invention, the tortillas will have a thickness of approximately 1.5 to 3.0 millimeters or greater. Also, while the present invention finds particular suitability for use in connection with the provision of corn or maize based masa flour, the skilled artisan will appreciate that the present invention finds usefulness in provision of wheat or wheat/com blends based formed taco shells.

The raw masa tortillas can optionally then be flash baked, resulting in raw masa tortillas with toast marks (block 220) as well as a reduced moisture content so as to thereby minimize fat take-up during the subsequent frying step. The toasted still soft and flexible tortillas are then formed into self-standing taco shells having substantially flat bases (block 230).

During the forming process, the tortillas are placed on molds and the tortillas conform to the molds (block 230). The molds can be a wire mesh mold, a wire cage mold, a combination wire mesh/cage mold, or a conventional mold having upper and lower plates. In either case, the molds are flat-bottomed and have cross-sectional elevations like the self-standing taco shells 110 shown in FIGS. 3a, 3b and 3c and as discussed above. Like the taco shells 110 illustrated in FIGS. 3a, 3b and 3c, the curved segments of the mold may have large, medium or small radii as discussed above.

The conformed tortillas are then fried and adopt the form of the molds (block 240). The tortillas exit the flyer as fried self-standing taco shells having substantially flat bases and a moisture content of less than about 6%. Optionally, the fried tacos can be partially defatted by oil draining and/or hot air oil removal. Since the formed tacos are still plastic or pliable for short periods while still hot immediately after frying, care should be taken to preserve the desired square bottomed shape. Oil is allowed to drain from the taco shells as they cool (block 250) and harden. In another embodiment, the tortillas are baked to a final moisture content of less than 6% to form low fat shaped rigid tacos. A number (e.g., 3-6) of the cooled hardened rigid taco shells are then nested (block 260) together into nested quantities and these nested quantities preferably provided with an intermediate spacer (not shown) and packaged (block 270) such as by providing one or more of the nested quantities onto a support board and then a film over wrap.

Minimizing the formation of discontinuities (e.g., bubbles and voids) in a taco shell can be a challenge when commercially producing taco shells. Discontinuities in taco shells can be minimized by providing masa flour of the proper granulation, using the proper ratios of ingredients, maintaining the proper moisture level in the dough, baking and frying properly, and avoiding the use of taco shell molds having complex geometries. Because the flat-bottomed molds have simple geometric characteristics, the tortillas readily conform to the molds, minimizing the potential for the formation of destabilizing discontinuities, especially those at the base 120 of the shell 110.

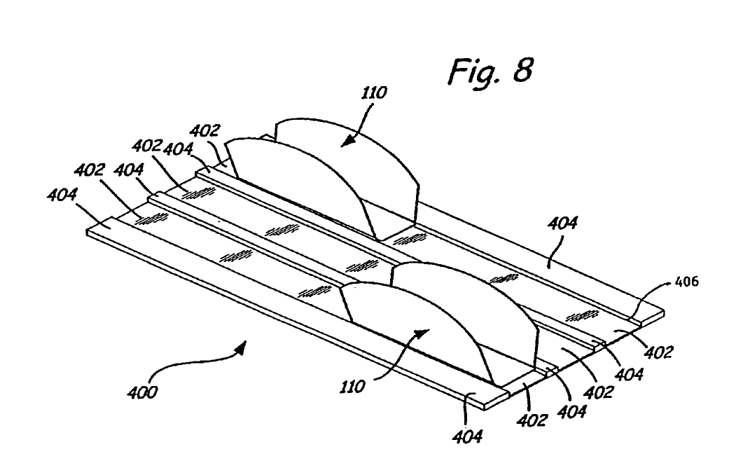

A method of using a self-standing taco shell 110 having a substantially flat base 120 will now be described by referring to the process flow chart illustrated in FIG. 7. A flat preparation surface 112 is located (block 300). One or more self-standing taco shells 110, having substantially flat bases 120 and characteristics as discussed above and illustrated in FIGS. 3a, 3b and 3c, are selected (block 310) and placed upright on the flat preparation surface 112 (block 320). Alternatively, one or more self-standing taco shells 110, having substantially flat bases 120 and characteristics as discussed above and illustrated in FIGS. 3a, 3b and 3c, are selected (block 310) and simply held or supported in an upright position. Each shell 110 is then filled with taco filling (e.g., lettuce, beans, cheese, cooked meat or poultry, sauce, sour cream, guacamole, or the like) (block 330). For example, FIG. 8 shows a tray 400 that may be used in conjunction with the taco shell 110 of the present invention to prepare tacos, store tacos, or present tacos to consumers. The tray 400 has a surface 402 upon which a taco shell 110 can be placed. The tray also has a structure 404 that provides at least one support surface 406. The surfaces 402 can be sized by appropriately spacing the structures 404 such that the support surfaces 406 further stabilize the taco shell 110 when it is in a standing position. As such, while the taco shell 110 is a stable, self-standing structure, depending on the environment, one or more support surfaces 406 may be used to further stabilize the taco shell 110 during preparation of the tacos for storing tacos, or for presentation of the tacos for sale.

In one embodiment of the invention, the taco shell 110 is reheated prior to being filled with heatable taco filling (i.e., meat, poultry or bean filling). In another embodiment, heatable filling is placed in the taco shell 110 and then preheated. In another embodiment, an individual or machine fills one or more taco shells 110 with heatable filling and then leaves the one or more tacos in an upright position for another individual to or machine to fill with other types of taco filling. Finally, in one embodiment, an individual or machine leaves one or more taco shells 110 in an upright position for another individual or machine to fill with taco filling.

The self-standing taco shell 110 makes it easier to prepare multiple tacos at the same time. This advantage is especially desirable in fast food, cafeteria and party environments where multiple tacos are being prepared at one time.

Still another advantage of the present tacos is that even if taco breakage occurs along either connection between flat base and sidewall, the flat base and remaining sidewall forms a ledge minimizing loss of the added fillings to allow for consumption completion with reduced mess.

Also, another advantage of a taco made using the taco shell 110 of the present invention may be presented for consumption in an upright and filled orientation.

Although the present invention has been described with reference to preferred embodiments, persons skilled in the art will recognize that changes may be made in form and detail without departing from the spirit and scope of the invention.

We claim:

1. A stable, self-standing, taco shell, comprising:
a first sidewall and a second sidewall interconnected by a substantially flat base, the taco shell configured so the height of the taco shell is approximately 1.50 to 4.0 times the width of the base.

2. The taco shell of claim 1 wherein the height of the taco shell is about 1.75 to 3.35 times the width of the base.

3. The taco shell of claim 1 wherein the height of the taco shell is about 2.0 to 3.0 times the width of the base.

4. The taco shell of claim 1 wherein the height of the taco shell is about 2.0 to 2.5 times the width of the base.

5. A stable, self-standing, taco shell, comprising:
a first sidewall and a second sidewall interconnected by a substantially flat base, the taco shell configured so the height of the taco shell is about 50 to 110 millimeters and the width of the base is at least about 10 millimeters.

6. The taco shell of claim 5 wherein the base width of the taco shell is about 16 millimeters or greater.

7. The taco shell of claim 5 wherein the base width of the taco shell is about 19 millimeters or greater.

8. The taco shell of claim 5 wherein the base width of the taco shell is about 21 millimeters or greater.

9. The taco shell of claim 5 wherein the base width of the taco shell is about 25 to 26 millimeters.

10. The taco shell of claim 5 wherein the height of the taco shell is about 57 to 77 millimeters and the base width of the taco shell is at least about 16 millimeters or greater.

11. The taco shell of claim 5 wherein the height of the taco shell is about 57 to 70 millimeters and the base width of the taco shell is about 19 millimeters or greater.

12. The taco shell of claim 5 wherein the height of the taco shell is about 57 to 70 millimeters and the base width of the taco shell is about 25 to 26 millimeters.

13. The taco shell of claim 5 wherein the height of the taco shell is about 57 to 70 millimeters and the base width of the taco shell is about 21 millimeters or greater.

14. A method of making a stable, self-standing, taco shell, comprising:
providing a tortilla; and
placing the tortilla on a mold configured so the resulting taco shell has a first sidewall and a second sidewall interconnected by a substantially flat base, and the height of the resulting taco shell is about 1.50 to 4.0 times the base width of the taco shell.

15. The method of claim 14 wherein the height of the resulting taco shell is about 1.75 to 3.35 times the width of the base.

16. The method of claim 14 wherein the height of the resulting taco shell is about 2.0 to 3.0 times the width of the base.

17. The method of claim 14 wherein the height of the resulting taco shell is about 2.0 to 2.5 times the width of the base.

18. A method of using a stable, self-standing, taco shell, comprising:
locating a flat surface;
selecting at least one stable, self-standing, taco shell having a first sidewall and a second sidewall interconnected by a substantially flat base, the taco shell configured so the height of the taco shell is about 1.50 to 4.0 times the width of the base;
placing the at least one taco shell upright on the flat surface; and
filling the at least one taco shell with taco filling.

19. The method of claim 18 wherein the height of the taco shell is about 1.75 to 3.35 times the width of the base.

20. The method of claim 18 wherein the height of the taco shell is about 2.0 to 3.0 times the width of the base.

21. The method of claim 18 wherein the height of the taco shell is about 2.0 to 2.5 times the width of the base.

22. The method of claim 18, wherein the act of filling the at least one taco shell with taco filling is practiced prior to placing the at least one taco shell upright on the flat surface.

23. A stable, self-standing, taco shell, comprising:
a first sidewall element;
a second sidewall element;
a substantially flat base element;
a first curved element interconnecting the first sidewall element to the flat base element; and
a second curved element interconnecting the second sidewall element to the flat base element.

24. The taco shell of claim 23 wherein at least one the elements has a thickness of less than 1.5 millimeters.

25. The taco shell of claim 23 wherein at least one the elements has a thickness of at least 1.5 millimeters.

26. The taco shell of claim 23 wherein at least one of the curved elements has a radius of about 6 millimeters or greater.

27. The taco shell of claim 23 wherein at least one of the curved elements has a radius of about 3 to 6 millimeters.

28. The taco shell of claim 23 wherein at least one of the curved elements has a radius of about 3 millimeters or less.

29. A method of making a stable, self-standing, taco shell, comprising:
providing a tortilla; and
placing the tortilla on a mold configured so the resulting taco shell has a first sidewall element, a second sidewall element, a substantially flat base element, a first curved element interconnecting the first sidewall element to the flat base element, and a second curved element interconnecting the second sidewall element to the flat base element.

30. The taco shell of claim 29 wherein at least one the elements has a thickness of less than 1.5 millimeters.

31. The taco shell of claim 29 wherein at least one the elements has a thickness of at least 1.5 millimeters.

32. The method of claim 29 wherein at least one of the curved elements has a radius of about 6 millimeters or greater.

33. The method of claim 29 wherein at least one of the curved elements has a radius of about 3 to 6 millimeters.

34. The method of claim 29 wherein at least one of the curved elements has a radius of about 3 millimeters or less.

35. A method of using a stable, self-standing, taco shell, comprising:
locating a flat preparation or use surface;
selecting at least one self-standing, taco shell having a first sidewall element, a second sidewall element, a substantially flat base element, a first curved element interconnecting the first sidewall element to the flat base element, and a second curved element interconnecting the second sidewall element to the flat base element;
placing the at least one taco shell upright on the preparation or use surface; and
filling the at least one taco shell with taco filling.

36. The taco shell of claim 35 wherein the act of selecting includes selecting a self-standing taco shell with at least one of the elements having a thickness of less than 1.5 millimeters.

37. The taco shell of claim 35 wherein the act of selecting includes selecting a self-standing taco shell with at least one of the elements having a thickness of at least 1.5 millimeters.

38. The method of claim 35 wherein the act of selecting includes selecting a self-standing taco shell with at least one of the curved elements having a radius of about 6 millimeters or greater.

39. The method of claim 35 wherein the act of selecting includes selecting a self-standing taco shell with at least one of the curved elements having a radius of about 3 to 6 millimeters.

40. The method of claim 35 wherein the act of selecting includes selecting a self-standing taco shell with at least one of the curved elements having a radius of about 3 millimeters or less.

41. The method of claim 35, wherein the act of filling the at least one taco shell with taco filling is practiced prior to placing the at least one taco shell upright on the preparation or use surface.

42. A method of preparing a taco, comprising:
placing on a generally flat surface a self-standing taco shell having a volume; and
filling at least a portion the volume of the self-standing taco shell with an edible foodstuff.

43. The method of 42 then further comprising filling at least a portion of the volume with at least another edible foodstuff.

44. The method of claim 42, wherein the act of placing comprises placing at least two self-standing taco shells each having a volume on a surface.

45. The method of claim 44 further comprising filling a portion of the volume of each of the self-standing taco shells with an edible foodstuff.

46. The method of claim 45, wherein the act of filling comprises filling a portion of the volume of each of the self-standing taco shells with an edible foodstuff that includes meat.

47. The method of claim 45, wherein the act of filling comprises filling a portion of the volume of each of the self-standing taco shells with an edible foodstuff that includes beans.

48. The method of claim 46 further comprising filling at least a portion of the volume of each self-standing taco shell with at least one of meat, vegetables, cheese and taco sauce.

49. The method of claim 47 further comprising filling at least a portion of the volume of each self-standing taco shell with at least one of meat, vegetables, cheese and taco sauce.

50. The method of claim 42, wherein the act of placing on a surface a self-standing taco shell includes placing the taco shell on a surface with at least one support surface to further stabilize the taco shell in a standing position.

51. The method of claim 42, wherein the act of placing on a surface a self-standing taco shell includes placing the taco shell on a surface with more than one support surface to further stabilize the taco shell in a standing position.

52. The method of claim 44, wherein the act of placing on a surface at least two self-standing taco shells includes placing each taco shell on a surface with at least one support surface to further stabilize the taco shell in a standing position.

53. The method of claim 44, wherein the act of placing on a surface at least two self-standing taco shells includes placing each taco shell on a surface with more than one support surface to further stabilize the taco shell in a standing position.
